(19) United States
(12) Patent Application Publication
(10) Pub. No.: US 2016/0299719 A1
(43) Pub. Date: Oct. 13, 2016

(54) MEMORY DEVICE AND METHOD FOR DATA EXCHANGING THEREOF

(71) Applicant: MONTAGE TECHNOLOGY (SHANGHAI) CO., LTD., Shanghai (CN)

(72) Inventors: Jie Liu, Shanghai (CN); Qingjiang Ma, Shanghai (CN)

(21) Appl. No.: 14/956,395

(22) Filed: Dec. 2, 2015

(30) Foreign Application Priority Data
Apr. 9, 2015 (CN) 201510167194.9

(51) Int. Cl. G06F 3/06

(52) U.S. Cl. CPC G06F 3/0622; G06F 3/061; G06F 3/0656; G06F 3/0659; G06F 3/0685

(57) ABSTRACT

The application discloses a memory device. The memory device has a volatile memory module and a non-volatile memory module. The memory device receives a data access command from an external module through a memory interface and exchanges data with the external module accordingly. An access control module is coupled to the memory interface to receive the data access command. A non-volatile memory controller is coupled to the non-volatile memory module. The non-volatile memory module receives the data access command and exchanges data with the non-volatile memory module accordingly. A data buffering module is coupled to the volatile memory module, the non-volatile memory controller and the memory interface. The data buffering module is also coupled to the access controller module to receive the data access command. The data buffering module provides the data access command to the non-volatile memory controller to exchange data with the non-volatile memory controller according to the data access command. The data buffering module has a buffer memory for storing at least a portion of data exchanged through the data buffering module.

### CROSS REFERENCE TO RELATED APPLICATIONS

This application claims priority and benefits of Chinese Patent Application No. 201510167194.9 filed on Apr. 9, 2015, the entire content of which is incorporated herein by reference.

### TECHNICAL FIELD

The application generally relates to memory technology, and more particularly, to a memory device and a data exchange method for use with the memory device.

### BACKGROUND

Memories are generally classified into volatile memories and non-volatile memories. The volatile memory requires continuous power supply during operation, otherwise data stored therein may be lost. On the contrary, data loss due to power failure may not happen to the non-volatile memory, and data can be stored within the non-volatile memory even if power-failure occurs. Moreover, the non-volatile memory also has advantages of high storing density and low power consumption, but its data reading and writing speed is usually slower than that of the volatile memory.

In computer systems and smart devices, an internal memory, being a data exchange bridge between a central processing unit (CPU) and a mass storage medium such as a hard disk, is mainly used to store temporarily operational data and data exchanged with the hard disk. Therefore, the volatile memory, which has fast data reading and writing speed is usually used as the internal memory. In order for the power-failure data storage capability of the non-volatile memory, some internal memory products may integrate within their memory module both the volatile memory and the non-volatile memory. When the system is suddenly powered down, data can be transferred instantly from the volatile memory to the non-volatile memory to avoid loss of data. However, as the non-volatile memory within the internal memory products cannot be accessed directly, the data storage capability of the non-volatile memory cannot be fully used.

Thus, there is a need to improve the conventional memory to access the non-volatile memory thereof directly.

### SUMMARY

An objective of the application is to modify the conventional memories so as to access the non-volatile memories thereof directly.

In a first aspect of the application, there is provided a memory device. The memory device, comprises: a volatile memory module; a non-volatile memory module; a memory interface, wherein the memory device receives a data access command from an external module through the memory interface and exchanges data with the external module according to the data access command; an access control module coupled to the memory interface to receive the data access command; a non-volatile memory controller coupled to the non-volatile memory module, the controller being configured to receive the data access command and exchanging data with the non-volatile memory module according to the data access command; a data buffering module coupled to the non-volatile memory module, the non-volatile memory controller and the memory interface, the data buffering module being further coupled to the access control module to receive the data access command, and the data buffering module being configured to provide the data access command to the non-volatile memory controller to exchange data with the non-volatile memory controller; herein the data buffering module comprises a buffer memory, the buffer memory being configured to store at least a portion of data exchanged via the data buffering module.

For example, the volatile memory module includes such as static random access memories (SRAM), dynamic random access memories (DRAM) or other types of volatile memories; the non-volatile memory module comprises flash memories, electrically erasable programmable read-only memories (EEPROM), phase change memories (PCM) or other types of non-volatile memories. In some embodiments, the volatile memory module and the non-volatile memory module may be integrated on a same memory board. Moreover, the same memory board may comprise one or more volatile memory module chips, or one or more non-volatile memory module chips.

In some embodiments, the at least a portion of data exchanged via the data buffering module comprises data exchanged between the memory interface and the non-volatile memory controller.

In some embodiments, the at least a portion of data exchanged via the data buffering module further comprises data exchanged between the non-volatile memory module and the non-volatile memory controller;

In some embodiments, the data buffering module is configured to obtain or set status data of the non-volatile memory controller before exchanging data with the non-volatile memory controller.

In some embodiments, the memory device further comprises a data exchange channel coupled between the non-volatile memory controller and the data buffering module, the data exchange channel is configured to receive a data strobe signal and transfer a data access command and data between the non-volatile memory controller and the data buffering module according to the data strobe signal.

In some embodiments, the memory device further comprises: an access control bus coupled between the access control module and the data buffering module for transferring the data access commands from the access controller module to the data buffering module.

In some embodiments, the memory device further comprises: a power-failure saving signal channel coupled between the memory interface and the non-volatile memory controller, the power-failure saving signal channel is configured to receive a power-failure saving signal and provides the power-failure saving signal to the non-volatile memory controller; the non-volatile memory controller is further configured to control the access control module and the data buffering module in response to the power-failure saving signal to transfer data stored in the volatile memory module to the non-volatile memory module.

In some embodiments, the buffer memory is further configured to store operation information and/or command required for data exchange operation on the non-volatile memory module.

In some embodiments, the volatile memory module comprises a plurality of groups of volatile memory cells, the data buffering module comprises a plurality of groups of data buffering units, the buffer memory comprises a plurality of groups of buffer memory cells, and wherein each group of volatile memory cells corresponds to one group of data buffering units and one group of buffer memory cells.

In some embodiments, the memory interface is a double data rate (DDR) interface.

In another aspect of the application, there is further provided a computer system and a mobile terminal comprising the memory devices according to the forgoing aspect of the application.

In a further aspect of the application, there is provided a memory device. The memory device comprises: a volatile memory module; a non-volatile memory module; a memory interface through which the memory device receives a data access command from an external module and exchanges data with the external module according to the data access command; an access control module coupled to the memory interface to receive the data access command; a non-volatile memory controller coupled to the non-volatile memory module and configured to receive the data access command and exchange data with the non-volatile memory module according to the data access command; and a data buffering module with a buffer memory, the data buffering module being coupled to the non-volatile memory module, the non-volatile memory controller and the memory interface, and further coupled to the access control module to receive the data access command; and the buffer memory being configured to store data when data is exchanged between the non-volatile memory controller and the volatile memory module or between the non-volatile memory module and the memory interface, and not to store data when data is exchanged between the volatile memory module and the memory interface.

The foregoing has outlined, rather broadly, features of the present application. Additional features of the present application will be described, hereinafter, which form the subject of the claims of the present application. It should be appreciated by those skilled in the art that the conception and specific embodiments disclosed herein may be readily utilized as a basis for modifying or designing other structures or processes for carrying out the objectives of the present application. It should also be realized by those skilled in the art that such equivalent constructions do not depart from the spirit and scope of the present application as set forth in the appended claims.

### BRIEF DESCRIPTION OF THE DRAWINGS

The aforementioned features and other features of the present application will be further described in the following paragraphs by referring to the accompanying drawings and the appended claims. It will be understood that, these accompanying drawings merely illustrate certain embodiments in accordance with the present application and should not be considered as limitation to the scope of the present application. Unless otherwise specified, the accompanying drawings need not be proportional, and similar reference characters generally denote similar elements.

FIG. 1 shows a memory device 100 according to an embodiment of the application;

FIG. 2 shows a memory device 200 according to an embodiment of the application;

FIGS. 3A to 3F are flowcharts indicating setting status for or exchanging data with the non-volatile memory module controller via a data buffering module of the memory device shown in FIG. 2;

FIGS. 4A to 4B are flowcharts indicating that a CPU controls data exchanging between a volatile memory module and a non-volatile memory module of the memory device shown in FIG. 2;

FIGS. 5A to 5G are flowcharts indicating setting status for or exchanging data with the non-volatile memory module of FIG. 2 via the data buffering module of the memory device shown in FIG. 2;

FIG. 6 shows waveforms of data transferring with a data exchange channel.

### DETAILED DESCRIPTION OF THE PREFERRED EMBODIMENTS

The following detailed description refers to the accompanying drawings as a part of the present application. Unless otherwise stated in the context, similar symbols generally represent similar components in the accompanying figures. The illustrative embodiments described in the detailed description, the accompanying drawings and the claims are not limiting, and other embodiments may be adopted, or modifications may be made without deviating from the spirit and subject of the application. It should be understood that, the various aspects of the application described and graphically presented herein may be arranged, replaced, combined, divided and designed in many different configurations, and these different configurations are implicitly included in the application.

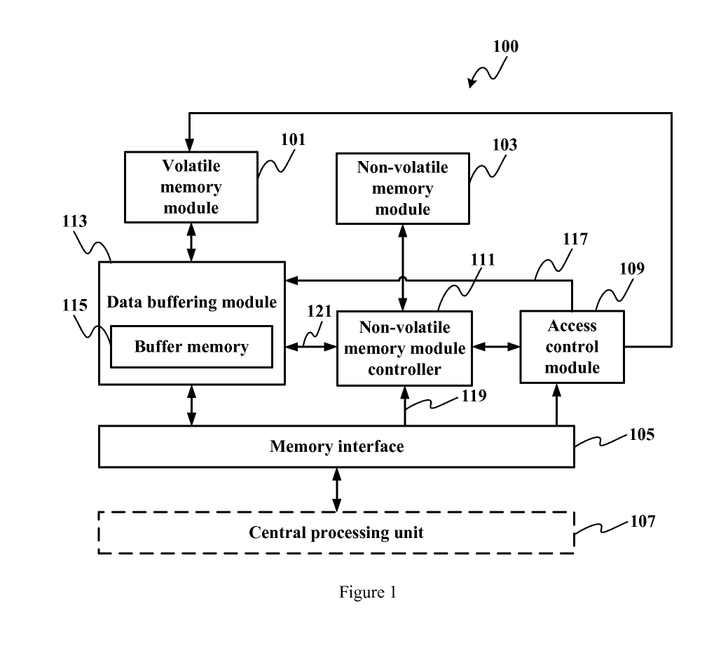

FIG. 1 shows a memory device 100 according to an embodiment of the application. The memory device 100 may be used in, for example, a computer system, a mobile device, a server, a smart device or other electronic devices as an internal memory thereof. The memory device 100 may be coupled to a CPU 107 to store operation data of the CPU and data exchanged between the CPU and a mass storage device such as a hard disk. In some embodiments, the electronic device having the memory device 100 may not use the mass storage device such as the hard disk, and instead, the memory device 100 may provide storage space for the mass storage application.

As shown in FIG. 1, the memory device 100 includes a volatile memory module 101 and a non-volatile memory module 103. The volatile memory module 101 may be a random access memory (RAM) while the non-volatile memory module 103 may be a flash memory. It should be noted that the volatile memory module 101 and the non-volatile memory module 103 mentioned herein may have a single memory chip, or two or more memory chips.

The memory device 100 is coupled to the CPU 107, which functions as an external module and exchanges with the memory device 100 through a memory interface 105. For example, the external module 107 may be the CPU or other modules external to the memory device 100 that require reading data from or writing data into the memory device 100. The external module 107 may send a data access command to the memory interface 105. Accordingly, the memory interface 105 receives the data access command and exchanges data with the external module 107 according to the dada access command. For example, the data access command may include: 1) a command indicating to write external data into the volatile memory module 101 through the memory interface 105; 2) a command indicating to write external data into the non-volatile memory module 103 through the memory interface 105; 3) a command indicating to transfer data from the volatile memory module 101 to the non-volatile memory module 103; 4) a command indicating to transfer data from the non-volatile memory module 103 to the volatile memory module 101; 5) a command indicating to read data from the volatile memory module 101 and provide the data to the external module 107 through the memory interface 105; or 6) a command indicating to read data from the non-volatile memory module 103 and provide the data to the external module 107 through the memory interface 105; etc. For ease of illustration, the commands relevant to the non-volatile memory module 103 of the aforementioned data access commands, including commands 2), 3), 4) and 6), are referred to as special data access commands, and the commands irrelevant to the non-volatile memory module 103 of the aforementioned data access commands, including commands 1) and 4), are referred to as normal data access commands hereinafter. Moreover, the data access commands also contain a destination address associated with data to be exchanged. The destination address may be a storage address of the data in the volatile memory module 101 or in the non-volatile memory module 103.

It should be noted that, in some applications, some or all of the aforementioned data access commands may be broken down to several sub-commands. Alternatively, some of the aforementioned data access commands may be combined together. For example, in some electronic systems or computer systems, the CPU may include a plurality of memory interfaces. Each of the plurality of memory interfaces is coupled to a memory device having a volatile memory module and/or non-volatile memory module, similar to the memory device shown in FIG. 1. Accordingly, a data access command may indicate transferring data from a first memory device coupled to a first memory interface to a second memory device coupled to a second memory interface. In particular, the data access command may indicate transferring data from a volatile memory module of the first memory device to a volatile memory module or a non-volatile memory module of the second memory device, or transferring data from a non-volatile memory module of the first memory device to the volatile memory module or the non-volatile memory module of the second memory device. In applications, the data may be first transferred to the memory interface coupled to the data-providing memory device, and further transferred, via the external module such as the CPU, to the memory interface coupled to the data-receiving memory device.

In some embodiments, the memory interface 105 may be a memory interface in accordance with the DDR standard, including the JEDEC DDR, DDR2, DDR3, DDR4 and other DDR memory standards. Moreover, the memory interface 105 may be a memory interface in accordance with other standards or protocols such as the SDRAM or RAMBUS memory standards.

The memory device 100 also includes an access control module 109 coupled to the memory interface 105 to receive the data access command. According to various data access commands it receives, the access control module 109 controls the memory device 100 to execute different data reading and writing operations, which will be elaborated hereinafter.

The memory device 100 has a non-volatile memory controller 111 for controlling the reading and writing operations on the non-volatile memory module 103. In particular, the non-volatile memory controller 111 receives the data access command and exchanges data with the non-volatile memory module 103 coupled thereto according to the received data access command, for example, writing data into the non-volatile memory module 103 or reading data from the non-volatile memory module 103. In other words, the non-volatile memory controller implements the data access to the non-volatile memory module.

The memory device 100 also includes a data buffering module 113. Data exchanging among the volatile memory module 101, the non-volatile memory controller 111 and the memory interface 105 can be implemented by the data buffering module 113. Specifically, the data buffering module 113 is coupled to the access control module 109 to receive the data access command from the access control module 109. Moreover, the data buffering module 113 is also coupled to the volatile memory module 101, the non-volatile memory controller 111 and the memory interface 105. In this way, under the control of the data access command, data can be exchanged among the volatile memory module 101, the non-volatile memory controller 111 and the memory interface 105. In some embodiments, the data buffering module 113 is coupled to the access control module 109 via an access control bus 117. The data access command can be provided from the access control module 109 to the data buffering module 113 via the access control bus 117.

The data buffering module 113 has a buffer memory 115 that is used to store at least a portion of data exchanged through the data buffering module 113, for example, the data exchanged between the memory interface 105 and the non-volatile memory controller 111, and/or the data exchanged between the volatile memory module 101 and the non-volatile memory controller 111. For example, when the memory device 100 is responsive to the aforementioned data access command 2) to write external data into the non-volatile memory module 103 through the memory interface 105, the external data to be written is first transferred to the data buffering module 113 through the memory interface 105 and stored in the buffer memory 115. The data buffering module 113 then communicates with the non-volatile memory controller 111 to send the data to be written, which is stored temporarily in the buffer memory 115, to the non-volatile memory controller 111, and the data is further written into the non-volatile memory module 103 by the non-volatile memory controller 111. For the other special data access commands including the aforementioned data access commands 3), 4) and 6), when executing the commands for data exchanging, the memory device 100 also stores data in the buffer memory 115. In some embodiments, the buffer memory 115 may also store the data exchanged between the data buffering module 113 and the volatile memory module 101. In other embodiments, when executing an operation corresponding to a normal data access command, i.e. the normal data access operation, the buffer memory 115 may not store the data to be exchanged. In other words, when data is read from the volatile memory module 101 and transferred to the memory interface 105, or when data is written into the volatile memory module 101 from the memory interface 105, the buffer memory 115 may not store the data to be exchanged. In this case, the data buffering module 113 is mainly used for timing adjustment of the data signals, i.e. buffering the data signals. It should be understood that, in some embodiments, the buffer memory 115 may also be used to store the data exchanged between the memory interface 105 and the volatile memory module 101.

The data reading and writing mechanism for the non-volatile memory module 103 is different from that for the volatile memory module 101. The non-volatile memory controller 111 is usually configured with status data stored in a status register. The status data includes information such as a bad block table of the non-volatile memory module 103, memory capacity and/or storage status. In some embodiments, the data buffering module 113 may obtain or configure the status data of the non-volatile memory controller 111 before exchanging data with the non-volatile memory controller 111 to execute the reading and writing operations on the non-volatile memory module 103 later. In particular, before reading out data stored in the non-volatile memory module 103 via the non-volatile memory controller 111, the data buffering module 113 first sends a status obtaining command to the non-volatile memory controller 111 to obtain or determine corresponding status data and store the status data in the buffer memory 115. After that, the data buffering module 113 provides the stored status data to the external module 107 through the memory interface 105. The external module 107 may determine the status of the non-volatile memory module 103 based on the status data to further execute data reading operation based on the status it determines. Similarly, before writing data into the non-volatile memory module 103 via the non-volatile memory controller 111, the data buffering module 113 first receives status data from the external module 107 through the memory interface 105 and stores the status data in the buffer memory 105. After that, the data buffering module 113 sends a status setting command to the non-volatile memory controller 111 and provides the stored status data to the non-volatile memory controller 111. In this way, the non-volatile memory controller 111 may complete status setting based on the status setting data to further execute a data writing operation.

In some embodiments, the status data and/or setting command required for executing data exchanging operations on the non-volatile memory module 103 by the non-volatile memory controller 111 may be stored in the buffer memory 115. For example, the access control module 109 may send the status data to the data buffering module 113 via the access control bus 117, so that the status data are further stored in the buffer memory 115 of the data buffering module 113. In this way, the data buffering module 113 may set the status of the non-volatile memory controller 111 directly based on the stored status data and/or setting command, or directly obtains the status data of the non-volatile memory controller 111.

In some embodiments, the memory device 11 may have a power-failure saving signal channel coupled between the memory interface 105 and the non-volatile memory controller 111. When an electronic device having the memory device 100 and the external module 107 is suddenly powered down, the external module 107 may send a power-failure saving signal to the memory interface 105. The power-failure saving signal is transmitted to the non-volatile memory controller 111 via the power-failure saving signal channel 119. Accordingly, in response to the power-failure saving signal, the non-volatile memory controller 111 will take over control of the whole memory device in replace of the CPU, and control the access control module and the data buffering module to control transferring of data from the volatile memory module 101 to the non-volatile memory module 103. Thus, the system operation data and other temporarily-stored data can be saved into the non-volatile memory module 103 to avoid data loss. A capacitor with large capacity may be used in the memory device 100 to provide power supply for the above operations.

In some embodiments, the memory device may have a data exchange channel 121 coupled between the non-volatile memory controller 111 and the data buffering module 113, the data exchange channel 121 is configured to receive a data strobe signal and transfer a data access command and data between the non-volatile memory controller 111 and the data buffering module 113 according to the data strobe signal.

In can be seen that, for the aforementioned memory device 100, due to the buffer memory 115 and its corresponding data access channel in the data buffering module 113, the external module 107 may execute the data access operation on the non-volatile memory module 103. In this way, the non-volatile memory module 103 may execute data storing operation independently from the volatile memory module 101, which may be used for mass data storage, for example. In some cases, a computer system using the memory device may not use a hard disk or other mass storage device, and instead, it may use the non-volatile memory module 103 in the memory device 100 as the mass storage device. Benefited from the relatively high data exchanging speed of the memory interface 105, the data exchanging speed of the computer system can be improved significantly. Moreover, the forgoing data access mechanism to the non-volatile memory module 103 will not affect data exchanging between the memory interface 105 and the volatile memory module 101, and thus can be well compatible with conventional internal memory standards.

In the embodiment shown in FIG. 1, the volatile memory module 101 of the memory device 100 has a group of volatile memory cells (not shown). Accordingly, the data buffering module 113 and the buffer memory 115 respectively have a group of units or cells (not shown). In applications, the volatile memory module may also have a plurality of groups of volatile memory cells according to different embodiments. Accordingly, the data buffering module and the buffer memory may also have a plurality of groups of units or cells.

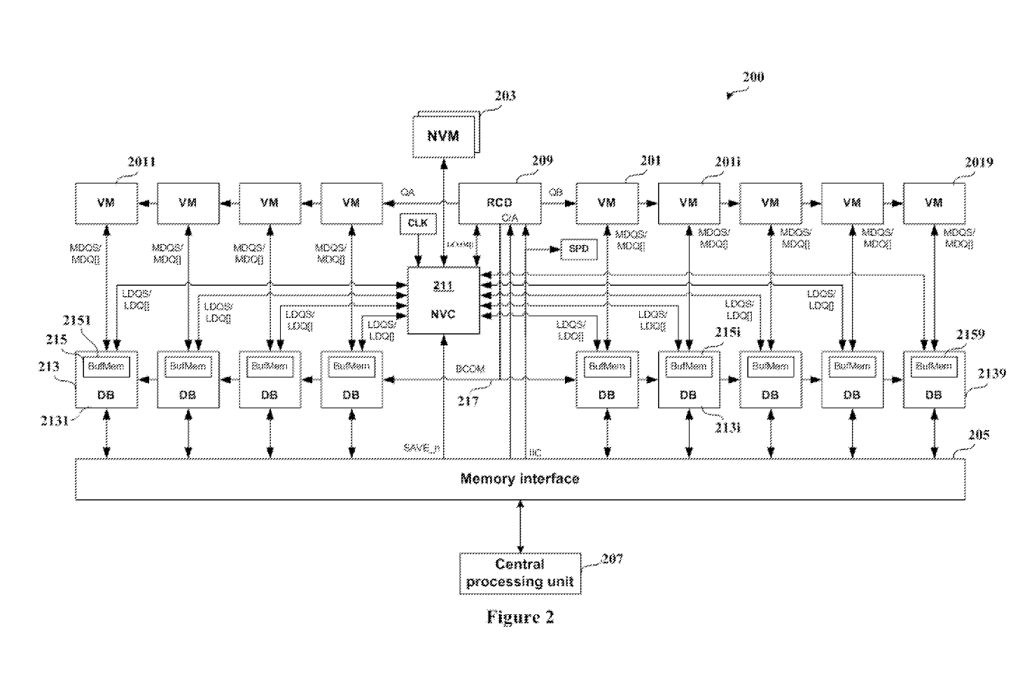

FIG. 2 shows a memory device 200 according to an embodiment of the application. As shown in FIG. 2, a distributed structure is employed in the memory device 200 where a volatile memory (VM) module 201 has a plurality of groups 201i of volatile memory cells, where i is a positive integer within a range (0, 9]. Accordingly, a data buffering (DB) module 213 has a plurality of groups 213i of data buffering units, and each group 213i has a group 215i of buffer memory cells, where i is a positive integer within the range (0, 9]. It should be noted that in other examples other values for i may be used, depending on the number of the plurality of groups of volatile memory cells, and the number of the plurality of groups of data buffering units and the buffer memory cells thereof.

Each group 213i of data buffering units is coupled to a non-volatile memory controller (NVC) 211 via channel LDQS/LDQ[ ], to a group 201i of volatile memory cells via channel MDQS/MDQ[ ], and to the memory interface 205 via channel DQS/DQ[ ]. The non-volatile memory controller 211 is further coupled to a non-volatile memory (NVM) module 203.

The memory device 200 exchanges data with a central processing unit (CPU) 207 via the memory interface 205. Specifically, the memory device 200 receives a data access command and exchanges data with the CPU 207 according to the received data access command. Moreover, the memory device 200 also has an access control (RCD) module 209 which receives the data access command from the memory interface 205 and sends the data access command to each group 213i of data buffering units of the data buffering module 213 via an access control bus 217.

In some embodiments, the memory device 200 may be in accordance with the DDR memory standard. For example, the memory device may be in accordance with the JEDEC DDR3 or LPDDR4 standard. In the following embodiments, the memory device 200 is exemplarily described with reference to the JEDEC DDR4 standard. However, a person skilled in the art would understand that it is not a limitation to the application and structure of the memory device 200.

As shown in FIG. 2, the access control module 209 is coupled to the memory interface 205 via a command/address (C/A) channel to receive the data access command. The data access command is provided by the CPU 207. For the memory interface 205 in accordance with the DDR4 standard, the C/A channel has pins A0-A17 and/or some other pins used for transmitting the data access commands and corresponding addresses. Pins A0-A9 of pins A0-A17 are used for transmitting the row addresses, and three pins A11, A13 and 17 are reserved and undefined. Therefore, one or more of the reserved pins A11, A13 and A17 may be further defined to transmit the special data access commands. In some embodiments, one or more of pins A11, A13 and A17 in combination with the original pin definitions (e.g., the read/write commands defined with pins A16, A15 and A14) and/or other pins (e.g. A[9:0]) may be used to define the special data access commands.

In particular, Table 1 shows an example of special data access commands defined with the combination of pin A11 and pins A[9:0]. The volatile memory module is abbreviated to VM, the non-volatile memory module is abbreviated to NVM, the non-volatile memory controller is abbreviated to NVC, the external module (i.e., the CPU 207) is abbreviated to Host, and the data buffering module is abbreviated to DB. The same abbreviations are used in the follow paragraphs.

TABLE 1

| Data | |
|---|---|
| access command | Description of data access function |
| RD | Read data from VM to Host |
| WR | Write data from Host to VM |
| RD_NVC | Transfer status data of NVC to the buffer |
| | memory of DB |
| WR_NVC | Set NVC status using the data stored in the buffer |
| | memory of DB |
| RD_FLASH | Read data from NVM to the buffer memory of DB |
| WR_FLASH | Write data from the buffer memory of DB to NVM |
| RD_DB | Read data from the buffer memory of DB to Host |
| WR_DB | Write data from Host to the buffer memory of DB |

In response to the received data access command, the access control module 209 sends the data access command to the data buffering module 213 via the access control bus 217. According to the DDR4 standard, the access control bus 217 is a 4-bit channel BCOM[3:0]. Table 2 shows the encoding of commands transmitted via the data access control bus according to an embodiment of the application. Specifically, code “1000” and code “1001” correspond to a normal write command and a normal read command, respectively, and code “1110” corresponds to the special data access command defined according to the present application. In other words, when the data access command received by the access control module 209 is the RD command or the WR command shown in Table 1, i.e., the normal data access command related to data accessing to the volatile memory module 201, the BCOM[3:0] codes provided by the access control module 209 via the access control bus 217 are “1000” and “1001”, respectively. However, if the data access command received by the access control module 209 may be commands in Table 1 other than the RD command and the WR command, i.e., the special data access command related to data accessing to the non-volatile memory module 203, the BCOM[3:0] codes provided by the access control module 209 via the access control bus 217 is “1110”, indicating that the object on which the data buffering module 213 will execute data access operation is the non-volatile memory module 203 or is related to the buffer memory 215.

TABLE 2

| Command | Encoding of BCOM[3:0] |
|---|---|
| Normal write | 1000 |
| Normal read | 1001 |
| MRS write | 1011 |
| BCW write | 1100 |
| BCW read | 1101 |
| Special data access | 1110 |
| Reserved | 1111 |
| No Operation (NOP) | 1010 |

After transmitting the above encoded commands, the access control module 209 continues to send the data access command received at its command/address channel via the access control bus 217, i.e., the special data access command or the normal data access command. Specifically, the data access command may be encoded as shown in Table 3.

TABLE 3

| Command | Encoding of BCOM[3:0] |
|---|---|
| RD_NVC | 0000 |
| WR_NVC | 0001 |
| RD_FLASH | 0010 |
| WR_FLASH | 0011 |
| RD_DB | 0100 |
| WR_DB | 0101 |
| Reserved (RSV) | 0110 |
| Reserved (RSV) | 0111 |

Furthermore, the data buffering module 213 exchanges data with the non-volatile memory controller 211 based on the data access command. In different embodiments, during the data exchanging process, the data buffering module 213 stores at least a portion of data exchanged therethrough into the buffer memory 215.

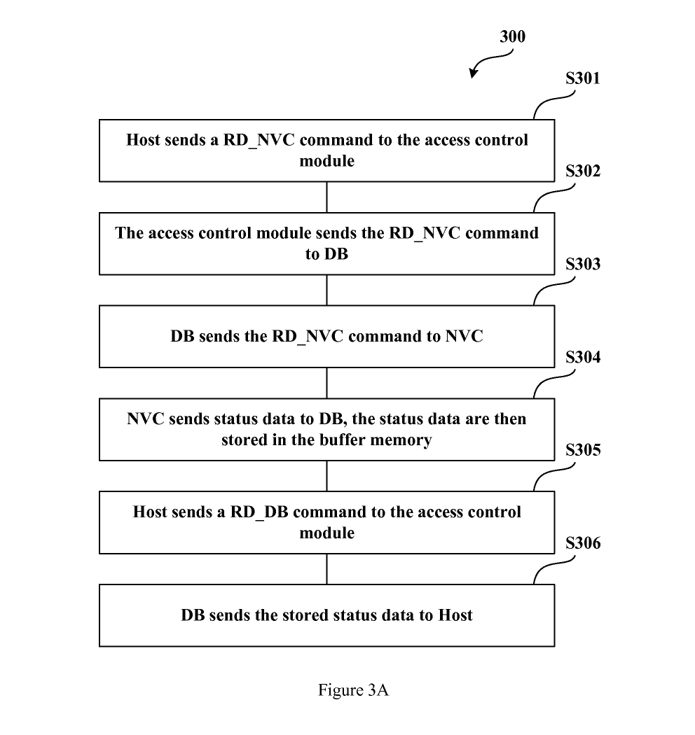

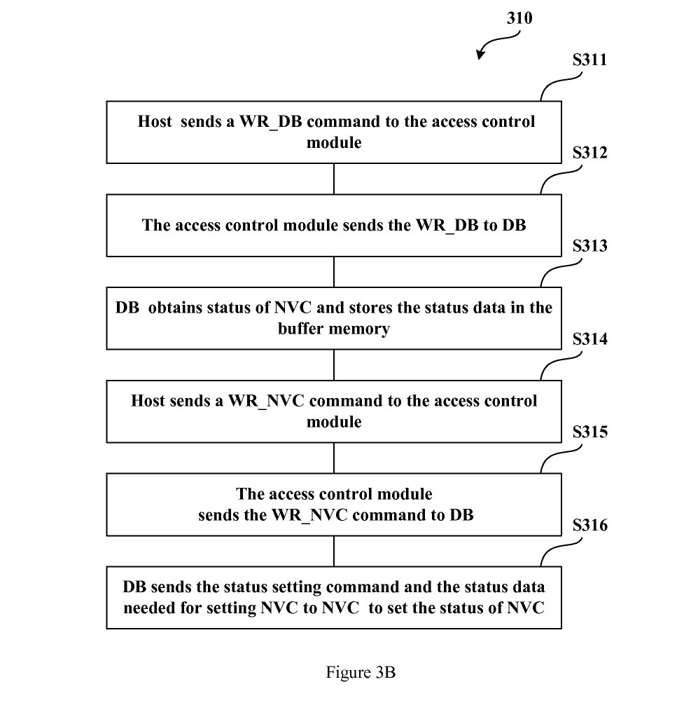

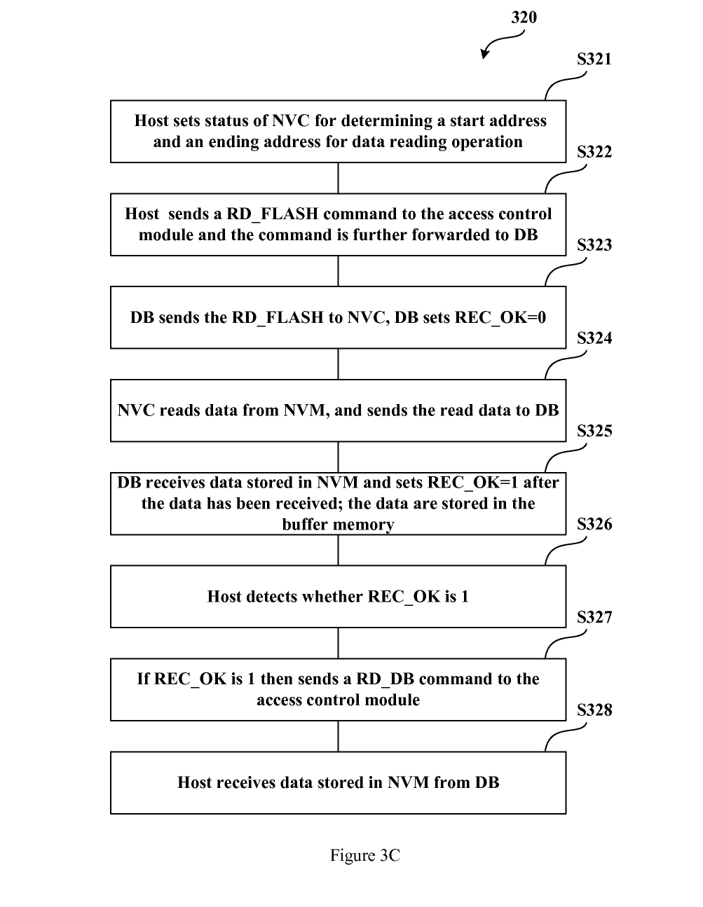

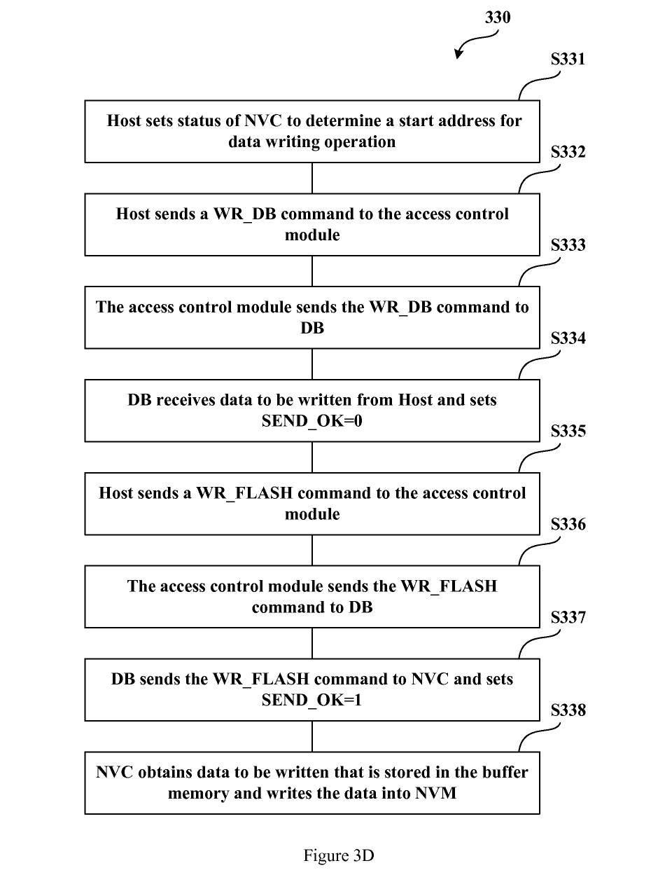

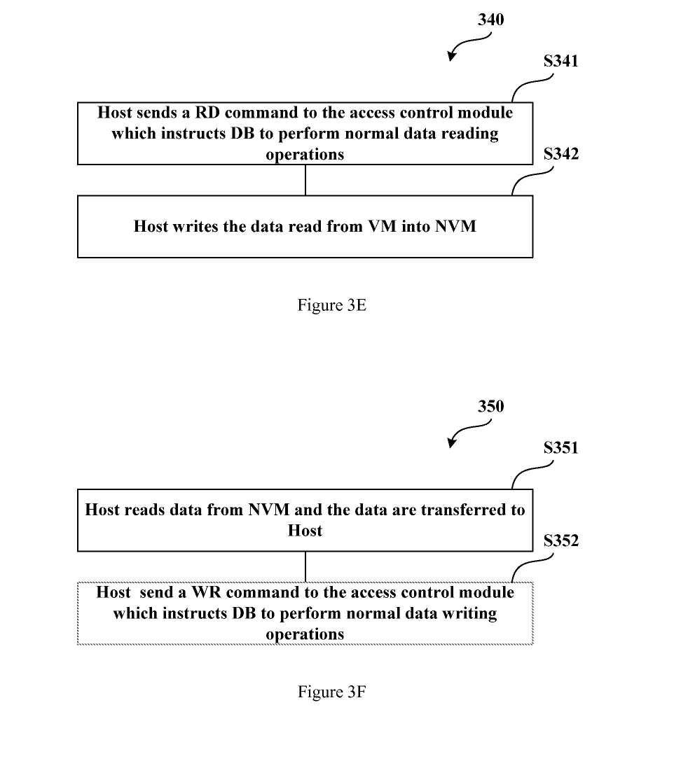

FIGS. 3A to 3F are flowcharts indicating processes for setting status for or exchanging data with the non-volatile memory controller 211 via the data buffering module 213. Hereinafter, the processes of the read/write operation and status setting operation on the non-volatile memory module 203 will be further described with reference to FIG. 2, FIGS. 3A to 3F and Table 1.

FIG. 3A is a process 300 that the CPU (Host) 207 obtains status data of the non-volatile memory controller (NVC) 211. As shown in FIG. 3A, in step S301, Host 207 sends a RD_NVC command to the access control module 209 via the memory interface. In step S302, the access control module 209 sends the RD_NVC command to the data buffering module (DB) 213 via the access control bus 217. In step S303, DB 213 sends the RD_NVC command to the NVC 211 via channel LDQS/LDQ. In step S304, the NVC 211 sends status data to the DB 213 via channel LDQS/LDQ and stores the status data in the buffer memory 215. In step S305, the Host 207 sends a RD_DB command to the access control module 209. In step S306, in response to the RD_DB command, the DB 213 sends the stored status data to the Host 207 via the memory interface. The Host 207 receives the status data accordingly, thereby completing the status data obtaining operation.

FIG. 3B is a process 310 that the Host 207 sets the status of the NVC 211. As shown in FIG. 3B, in step S311, the Host 207 sends a WR_DB command to the access control module 209. In step S312, the access control module 209 sends the WR_DB command to the DB 213 via the access control bus 217. In step S313, the DB 213 obtains the status data for setting the NVC 211 via channel DQ and stores the obtained status data in the buffer memory 215. In step S314, the Host 207 sends a WR_NVC command to the access control module 209. In step S315, the access control module 209 sends the WR_NVC command to the DB 213 via the access control bus 217. In step S316, the DB 213 sends a status setting command to the NVC 211 via channel LDQS/LDQ and then sends the stored status data to the NVC 211. Then in response to the status setting command, the NVC sets the status of the NVC 211 based on the received status data, thereby completing the status setting operation.

FIG. 3C is a process 320 that the Host 207 reads data from the non-volatile memory module (NVM) 203. As shown in FIG. 3C, in step S321, the Host 207 first executes the process 310 as shown in FIG. 3B to set the status of the NVC 211 for determination of a start address and an end address for read operation on the NVM 203. In step S322, the Host 207 sends a RD_FLASH command to the access control module 209, and further to the DB 213 via the access control bus 217. In step S323, the DB 213 sends the RD_FLASH command to the NVC 211 via channel LDQS/LDQ. In some embodiments, the DB 213 also sets register REG_OK=0. The register REG_OK is in the DB 213, indicating certain operation status of the DB 213. In step S324, in response to the RD_FLASH command, the NVC 211 reads data from the NVM 203 and sends the data to the DB 213 via channel LDQS/LDQ. In step S325, the DB 213 receives the data stored in and read from the NVM 203 via channel LDQS/LDQ and sets register REC_OK=1 upon receipt of the data. The data is stored temporarily in the buffer memory 215. In step S326, the Host 207 reads the register REC_OK and detects whether it is set to 1. In step 327, if the Host 207 detects register REC_OK=1, then it sends a RD_DB command to the access control module 209. In step S328, the Host 207 receives the data stored in the NVM 203 from the DB 213 via channel DQ, thereby completing the data reading operation.

In some embodiments, after step S325, the steps S326 to S328 may not be executed. Alternatively, the Host 207 may send the RD_DB command directly to the access control module 209. Then, the Host 207 receives from the DB 213 the data stored in the NVM 203 and receives the value of the register REC_OK. If REC_OK=1, then the received NVM data is determined as valid data. On the contrary, if REC_OK=0, then the received NVM data is determined as invalid data.

FIG. 3D is a process 330 that the Host 207 writes data into the NVM 203. As shown in FIG. 3D, in step S331, the Host 207 first executes the process 310 as shown in FIG. 3B to set the status of the NVC 211 for determination of a start address for writing data into the NVM 203. In step S332, the Host 207 sends a WR_DB command to the access control module 209. In step S333, the access control module 209 sends the WR_DB command to the DB 213 via the access control bus 217. In step S334, the DB 213 receives the data to be written from the Host 207 via channel DQ and sets register SEND_OK=1. The register SEND_OK is in the DB 213, indicating the operation status of the DB 213. The data to be written is temporarily stored in the buffer memory 215. In step S335, the Host 207 sends a WR_FLASH command to the access control module 209. In step S336, the access control module 209 sends the WR_FLASH command to the DB 213 via the access control bus 213. In step S337, the DB 213 sends the WR_FLASH command to the NVC 211 via channel LDQS/LDQ and sets register SEND_OK=1. In step S338, in response to the WR_FLASH command, the NVC 211 obtains the data to be written, which is stored in the buffer memory 215, and writes the data into the NVM 203, thereby completing the data writing operation.

FIG. 3E is a process 340 that the Host 207 instructs to transfer data from the volatile memory module (VM) 201 to the NVM 203. As shown in FIG. 3E, the process 340 can be divided into two steps in general. First, in step S341, the Host 207 sends a RD command to the access control module 209, which instructs the DB 213 to execute a normal data reading operation. In other words, data is read from the VM 201 and further transferred to the Host 207. Then in step S342, the process 330 shown in FIG. 3D is executed. The Host 207 writes into the NVM 203 the data read from the VM 201. In this way, the operation of data transfer from the VM 201 to the NVM 203 is completed.

FIG. 3F is a process 350 that the Host 207 instructs to transfer data from the NVM 203 to the VM 201. As shown in FIG. 3F, the process 350 can be divided into two steps in general. First, in step S351, the process 320 shown in FIG. 3C is executed. The Host 207 reads data from the NVM 203 and further to the Host 207. Then in step S352, the Host 207 sends a WR command to the access control module 209 which instructs the DB 213 to execute a normal data writing operation. In other words, the data read from the NVM 203 is transferred to the DB 213 by the Host 207 and further written into the VM 201. In this way, the operation of data transfer from the NVM 203 to the VM 201 is completed.

It can be seen that, by providing the protocols relating to the status setting commands and read/write commands shown in Table 1 and Table 2, as well as arranging the data memory 215 in the data buffer module 213, the CPU 207 can access directly to the non-volatile memory module 203 to fully use the storage capability of the memory device 200. In some specific scenarios, the non-volatile memory module 203 may have relatively large storage capacity so that it can be used as a mass storage device of a computer system or other electronic systems such as a mobile terminal. Correspondingly, it is not necessary to equip the computer system with an individual mass storage device such as a hard disk. Specifically, as the interaction interface between the CPU 207 and the memory device 200 has a data transmission speed much higher than the interface coupled to the hard disk, the CPU 207 can read or write data much faster, thereby improving the overall performance of the computer system.

Moreover, as the buffer memory 215 exchanges data with the non-volatile memory controller 211 via a channel separate from that of the volatile memory module 201, the access to the non-volatile memory module 203 will not affect data exchanging between the volatile memory module 201 and the memory interface 205 through the data buffering module 213. In other words, the memory device according to the embodiment of the application is well compatible with conventional memory standards and can be used in conventional computer systems.

In some embodiments, the memory device shown in FIG. 2 may use other data access protocols. Table 4 shows another group of data access commands defined with the combination of pins A13, A11, A[9:0] and A[16:14]. The volatile memory module is abbreviated to VM, the non-volatile memory module is abbreviated to NVM, the non-volatile memory controller is abbreviated to NVC, the external module is abbreviated to Host, and the data buffering module is abbreviated to DB.

TABLE 4

| Data access | |
|---|---|
| command | Description of data access function |
| RD | Read data from VM to Host |
| WR | Write data from Host into VM |
| RD_DRAM | Read data from VM into the buffer memory of DB |
| WR_DRAM | Write data from the buffer memory of DB into VM |
| RD_NVC | Transfer NVC status data to the buffer memory of DB |
| WR_NVC | Set NVC status using the data stored in the buffer |
| | memory of DB |
| RD_FLASH | Read data from NVM to the buffer memory of DB |
| WR_FLASH | Write from the buffer memory of DB into NVM |
| RD_DB | Read data from the buffer memory of DB to Host |
| WR_DB | Write data from Host into the buffer memory of DB |

Accordingly, when the access control module 209 sends the data access command via the access control bus 217, the data access command can be encoded as shown in Table 5.

TABLE 5

| Command | Encoding of BCOM[3:0] |
|---|---|
| RD_DRAM | 0000 |
| WR_DRAM | 0001 |
| RD_NVC | 0010 |
| WR_NVC | 0011 |
| RD_FLASH | 0100 |
| WR_FLASH | 0101 |
| RD_DB | 0110 |
| WR_DB | 0111 |

In can be seen that, different from the data access command sets shown in Tables 1 and 3, the data access command sets shown in Tables 4 and 5 further includes an operation of reading data from the volatile memory module 201 and storing the data in the buffer memory 215 of the data buffering module 213, and an operation of writing data stored in the buffer memory 215 into the volatile memory module 201. In this way, with the data buffering module 213 and the buffer memory 215 exchanging and storing data, the volatile memory module 201 and the non-volatile memory module 203 may exchange data directly, rather than via the external module 207 as shown in FIGS. 3E and 3F. Thus, data exchanging speed can be improved significantly.

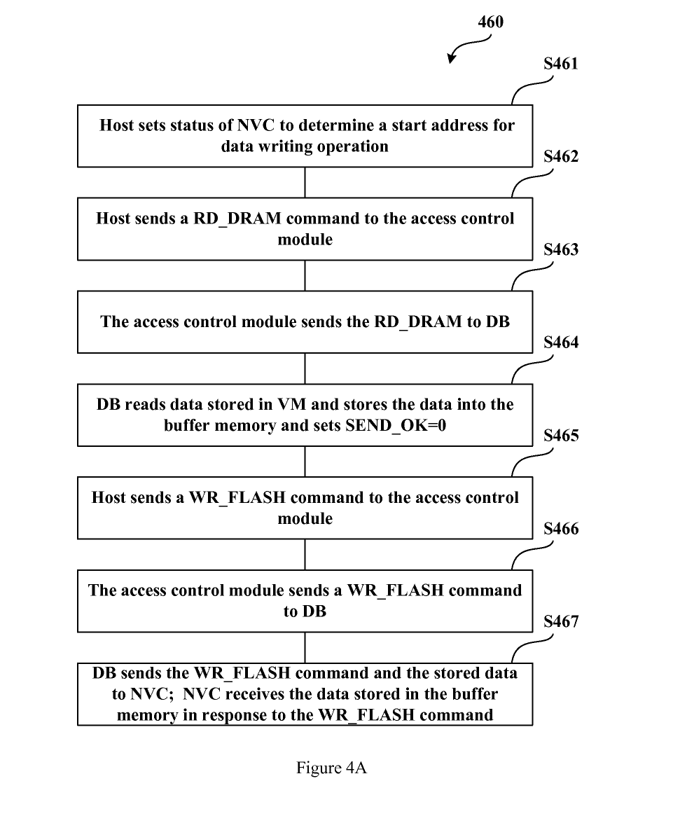

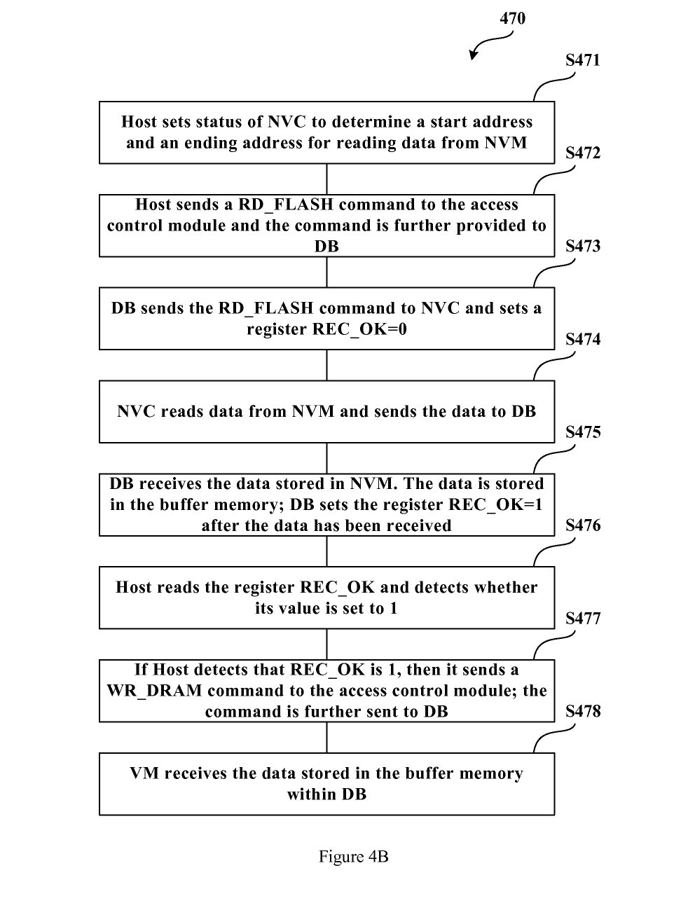

For the data access commands shown in Tables 4 and 5, the processes for the Host 207 obtaining status data of the NVC 211 and setting status of the NVC 211 can refer to relevant descriptions of FIGS. 3A and 3B, and the processes for the Host 207 exchanging data with the NVM 203 can refer to relevant descriptions of FIGS. 3C and 3D, which will not be elaborated herein. However, the processes for the Host 207 controlling the data exchanging between the VM 201 and the NVM 203 are shown in FIGS. 4A and 4B, which are different from the processes shown in FIGS. 3E and 3F. In the following, the processes of data exchanging between the VM 201 and the NVM 203 will be described with reference to FIGS. 4A and 4B.

FIG. 4A shows a process that the Host 207 controls reading data from the VM 201 and writing the data into the NVM 203. As shown in FIG. 4A, in step S461, the Host 207 first executes the process shown in FIG. 3B to set status of the NVC 211 to determine a start address for writing data into the NVM 203. In step S462, the Host 207 sends a RD_DRAM command to the access control module 209. In step S463, the access control module 209 sends the RD_DRAM command to the DB 213 via the access control bus 217. In step S464, in response to the RD_DRAM command, the DB 213 reads data stored in the VM 201 via the channel MDQ and stores the data into the buffer memory 215. Then the DB 213 sets a register SEND_OK=0. In step S465, the Host 207 sends a WR_FLASH command to the access control module 209. In step S466, the access control module 209 sends the WR_FLASH command to the DB 213 via the access control bus 217. In step S467, the DB 213 sends the WR_FLASH command and the stored data to the NVC 211 via the channel LDQS/LDQ and sets the register SEND_OK=1. In response to the WR_FLASH command, the NVC 211 receives the data stored in the buffer memory 215 and writes the data into the NVM 203 to complete the writing operation.

FIG. 4B shows a process that the Host 207 controls reading data from the NVM 203 and writing the data into the VM 201. As shown in FIG. 4B, in step S471, the Host 207 first executes the process shown in FIG. 3B to set status of the NVC 211 to determine a start address and an end address for writing data into the NVM 203. In step S472, the Host 207 sends a RD_FLASH command to the access control module 209 and the command is further provided to the DB 213 via the access control bus 217. In step S473, the DB 213 sends the RD_FLASH command to the NVC 211 via the channel LDQS/LDQ. In some embodiments, the DB 213 further sets a register REC_OK=1. In step S474, in response to the RD_FLASH command, the NVC 211 reads data from the NVM 203 and sends the data to the DB 213 via the channel LDQS/LDQ. In step S475, the DB 213 receives data stored in the NVM 203 via the channel LDQS/LDQ and sets the register REC_OK=1 when all the data has been received. The data are stored in the buffer memory 215. In step S476, the Host 207 reads the register REC_OK and detects whether it is set to 1. In step S477, if the Host 207 determines REC_OK=1, then it sends the WR_DRAM command to the access control module 209. The command is further sent to the DB 213 via the access control bus 217. In step S478, in response to the WR_DRAM command, the VM 201 receives the data stored in the buffer memory 215 within the DB 213 so as to complete the whole data transferring process. In can be understood that, if in step S477 the Host 207 determines that the value of REC_OK is 0, then it may wait and read the register REC_OK again. The process may not move forward to step S478 until it is detected that REC_OK=1.

Tables 6 and 7 show another data access protocol that can be used by the memory device 200 shown in FIG. 2. Table 6 shows data access commands defined based on the format of the command/address channel of the access control module 209. In particular, data access commands are defined with pin A11 in combination with pins A[9:0]. The volatile memory module is abbreviated to VM, the non-volatile memory module is abbreviated to NVM, the non-volatile memory controller is abbreviated to NVC, the external module is abbreviated to Host, and the data buffering module is abbreviated to DB.

TABLE 6

| Data access | |
|---|---|
| command | Description of data access function |
| RD | Read data from VM to Host |
| WR | Write data from Host into VM |
| RD_STS | Read operation information stored in the buffer |
| | memory of DB |
| WR_STS | Write operation information into the buffer memory of DB |
| RD_DB | Read data from the buffer memory of DB to Host |
| WR_DB | Write data from Host into the buffer memory of DB |

Accordingly, when the access control module 209 sends a data access command via the access control bus 217, the data access command can be encoded as shown in Table 7.

TABLE 7

| Command | Encoding of BCOM[3:0] |
|---|---|
| RD_STS | 0000 |
| WR_STS | 0001 |
| RD_DB | 0010 |
| WR_DB | 0011 |

It can be seen that, as the buffer memory 215 of the data buffering module 213 can be used to store data to be exchanged, as well as operation information and/or commands for data exchanging operations; thus, compared with the set of data access commands defined in Tables 1 and 3 or Tables 4 and 5, the set of data access commands defined in Tables 6 and 7 is simpler. The operation information stored in the buffer memory 215 may be used to instruct the data buffering module 213 to execute corresponding operations or processing, e.g. setting the registers in the data buffering module 213, setting the registers in the non-volatile memory controller 211, and special data access operations to be executed on the non-volatile memory module 203. The access control module can be simplified accordingly. All operation information is packed in the buffer memory 215 in form of protocol package. The DB 213 and the NVC 215 decode the protocol package and perform corresponding operations.

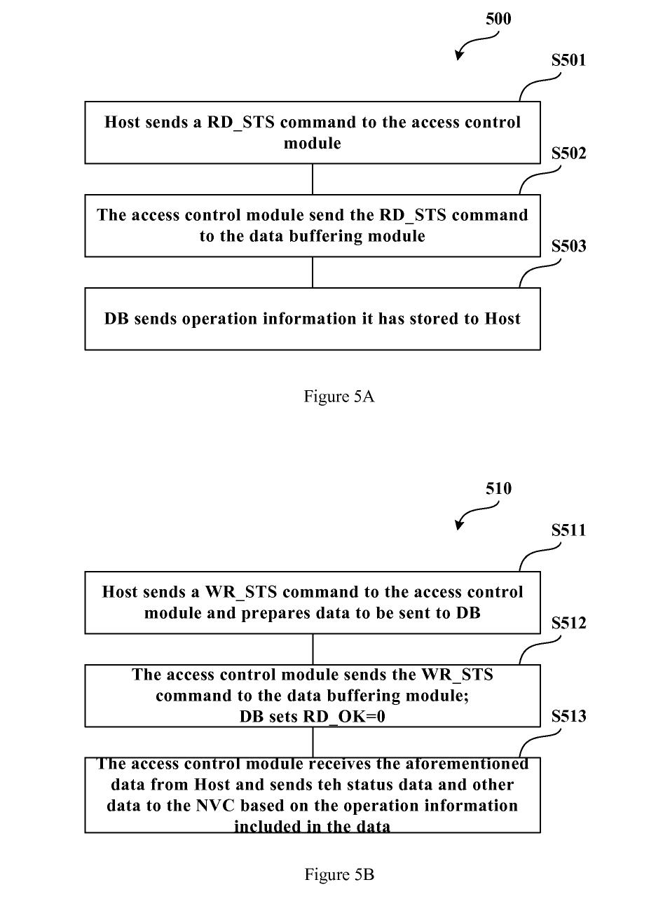

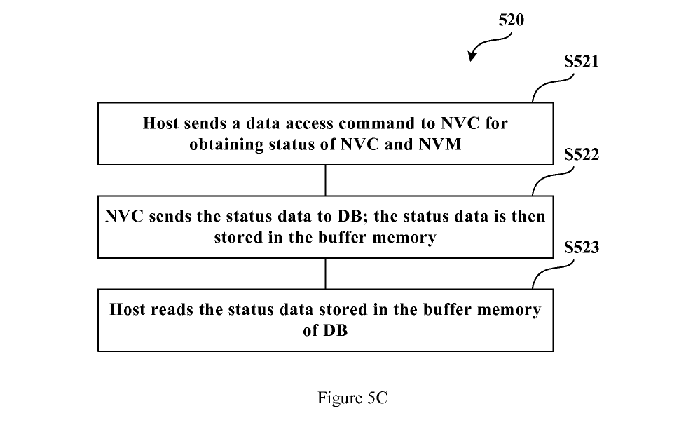

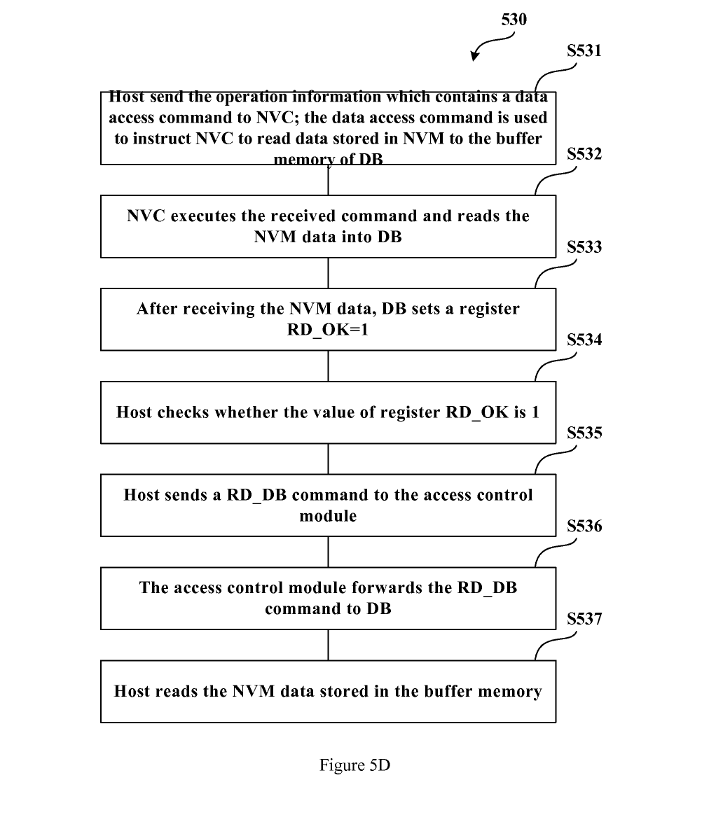

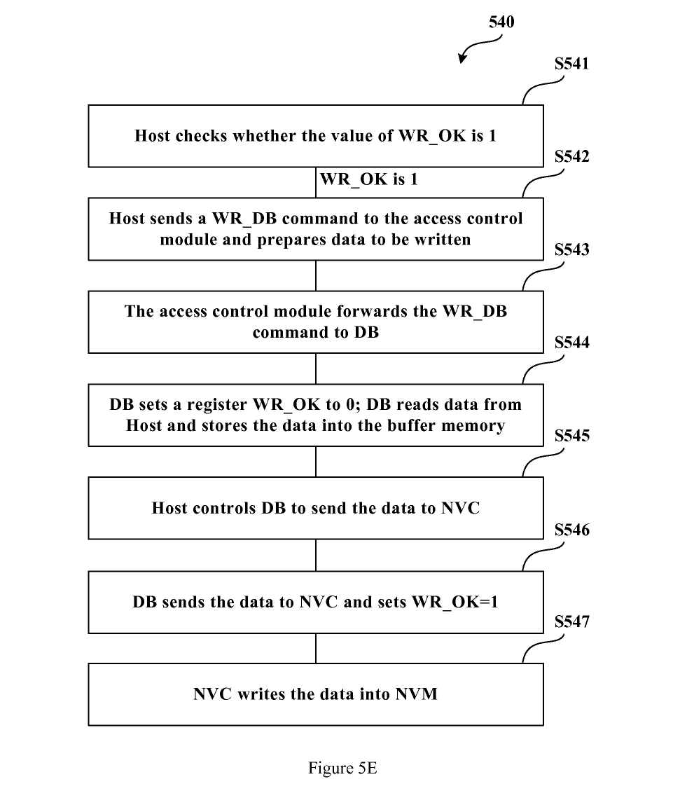

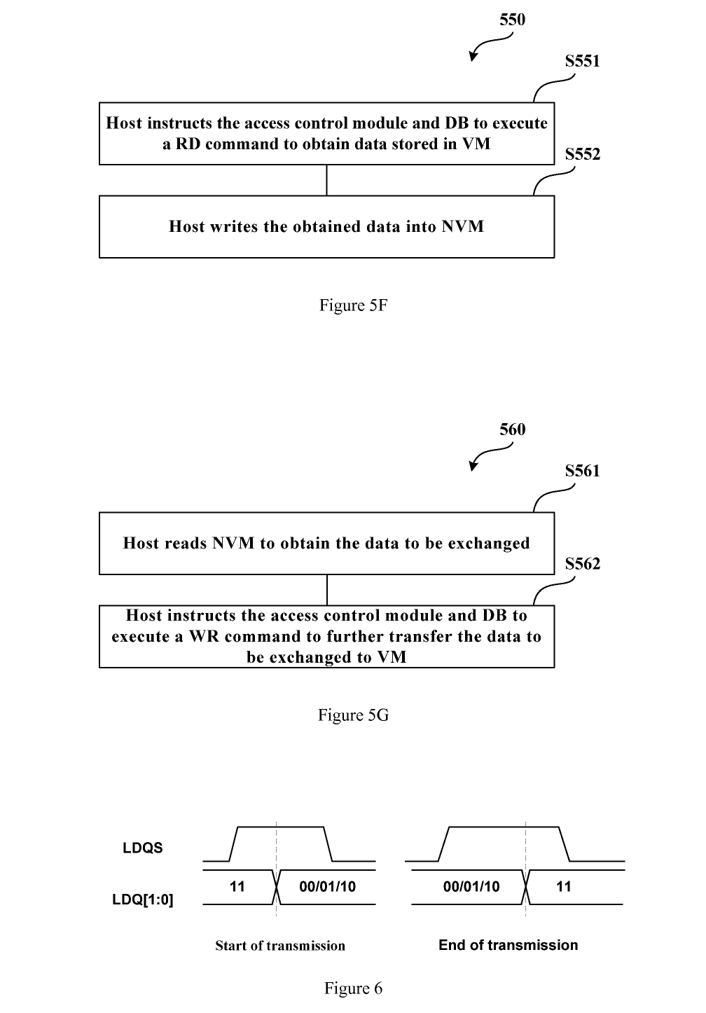

FIGS. 5A to 5G show flowcharts for setting status of the non-volatile memory module 211 or exchanging data with the non-volatile memory module 211 via the data buffering module 213. In the following, with reference to FIG. 2, FIGS. 5A to 5G and Tables 6 to 7, the processes for reading, writing, status setting and other operations to the non-volatile memory module 203 will be further described.

FIG. 5A shows a process 500 that the Host 207 reads operation information from the DB 213. As shown in FIG. 5A, in step S501, the Host 207 sends a RD_STS command to the access control module 209. In step S502, the access control module 209 sends the RD_STS command to the data buffering module 213 via the access control bus 217. In step S503, in response to the RD_STS command, the DB 213 sends the operation information stored therein to the Host 207 via the channel DQ and the memory interface 205. The Host 207 thus obtains the operation information it needs.

FIG. 5B shows a process 510 that the Host 207 sets status data of the NVC 211 and the NVM 203 or sends a data access command to the NVC 211. As shown in FIG. 5B, in step S511, the Host 207 sends a WR_STS command to the access control module 209 and prepares data to be sent to the DB 213, which includes operation information and status data. In step S512, the access control module 209 sends the WR_STS command to the data buffering module 213 via the access control bus 217 and sets a register RD_OK=0. In step S513, the data buffering module 213 receives the aforementioned data from the Host 207 and further sends the status data and/or other data to the NVC 211 based on the operation information included in the data received. The status of the NVC 211 is thus set.

FIG. 5C shows a process 520 that the Host 207 reads status data of the NVC 211 and the NVM 203. As shown in FIG. 5C, in step S521, the Host 207 first executes the process 510 shown in FIG. 5B to send the data access command to the NVC 211 to determine status of the NVC 211 and the NVM 203. In step S522, in response to the received data access command, the NVC 211 sends the status data to the DB 213 via the channel LDQS/LDQ. The status data is then stored in the buffer memory 215. In step S523, the Host 207 executes the process shown in FIG. 5A, the status data of the NVC and the NVM stored in the buffer memory 215 of the DB 213 can be read out.

FIG. 5D shows a process 530 that the Host 207 reads data from the NVM 203. As shown in FIG. 5D, in step S531, the Host 207 first executes the process 510 shown in FIG. 5B to send the operation information containing a data access command to the NVC 211. The data access command is used to instruct the NVC 211 to read data stored in the NVM 203 to the buffer memory 215 of the DB 213. In step S532, the NVC 211 executes the received command and read the data from the NVM 203 to the DB 213 via the channel LDQS/LDQ. In step S533, after receiving the data from the NVM 203, the DB 213 sets a register RD_OK=1. In step S534, the Host 207 uses the process 500 shown in FIG. 5A to check whether the value of RD_OK is 1. If the Host 207 determines that the value of the register RD_OK is 1, then in step S535, it sends a RD_DB command to the access control module 209. In step S536, the access control module 209 forwards the RD_DB command to the DB 213. In step S537, the Host 207 reads the NVM data stored in the buffer memory 215 via the channel DQ. In this way, data transferring from the NVM 203 to the Host 207 is thus completed.

FIG. 5E shows a process 540 that the Host 207 writes data into the NVM 203. As shown in FIG. 5E, in step S541, the Host 207 executes the process 500 shown in FIG. 5A and checks whether the value of a register WR_OK is 1. If it is detected that the value of WR_OK is 1, then in step S542, the Host 207 sends a WR_DB command to the access control module 209 and prepares data to be written. Then in step S543, the access control module 209 forwards the WR_DB command to the DB 213. In step S544, the DB 213 sets the register WR_OK to be 1, receives data from the Host 207, and stores the received data into the buffer memory 215. After that, in step S545, the Host 207 executes the process shown in FIG. 5B to control the DB 213 to send the data to the NVC 211. In step S546, the DB 213 sends the data to the NVC 211 and sets WR_OK=1. After that, in step S547, the NVC 211 writes data into the NVM 203. In this way, data can be written into the NVM 203 by the Host 207.

FIG. 5F shows a process 550 that the Host 207 instructs to transfer data from the VM 201 to the NVM 203. As shown in FIG. 5F, in step S551, the Host 207 instructs the access control module 209 and the DB 213 to execute a RD command to obtain data stored in the VM 201. In step S552, the process 540 shown in FIG. 5E is executed to write the obtained data into the NVM 203. In this way, data transferring from the VM 201 to the NVM 203 is completed.

FIG. 5G shows a process 560 that the Host 207 instructs to transfer data from the NVM 203 to the VM 201. As shown in FIG. 5G, in step S561, the process 530 shown in FIG. 5D is executed that the Host 207 reads the NVM 203 to obtain data to be exchanged. In step S562, the Host 207 instructs the access control module 209 and the DB 213 to execute a WR command to further forward the data to be exchanged to the VM 201. In this way, data transferring from the NVM 203 to the VM 201 is thus completed.

Still referring to FIG. 2, each group 213i of data buffering units communicates with the non-volatile memory controller 211 via the data exchange channel LDQS/LDQ. The data exchange channel LDQS/LDQ is used to receive a data strobe signal. Under the control of the data strobe signal, the data exchange channel LDQS/LDQ may further transfer data access commands and data (which contain status data and operation information). In the embodiment shown in FIG. 2, the data exchange channel LDQS/LDQ is a bi-directional channel.

FIG. 6 shows waveforms corresponding to data transferring via the data exchange channel. As shown in FIG. 6, LDQ[1:0] of the data exchange channel is pulled to high level when it is idle. The state that LDQS=1′b1 and LDQ[1:0]=2′b11 represents that these two channels are idle. The data buffering module 213 and the non-volatile memory controller 211 can only occupy data exchange channel when the channel is idle. When the data buffering module 213 or the non-volatile memory controller 211 is expected to occupy the data exchange channel LDQ, it sends a starting signal in advance. The starting signal causes the data exchange channel to change from 2′b11 to non-2′b11 value, e.g., 2′b00, 2′b10 or 2′b01, when LDQS=1′b1. After that, the data exchange channel may be used to transfer data access commands and data. When transferring is close to end, the data buffering module 213 or the non-volatile memory controller 211 which occupies the data exchange channel further sends an ending signal. The ending signal causes the data exchange channel to change from the non-2′b11 value to 2′b11 when LDQS=1′b1. Thus, the data exchange channel is not occupied. It can be understood that the above descriptions about transmission methods of the data exchange channel are only exemplary and can be modified according to specific application requirements.

It should be noted that although several modules or sub-modules of the memory device have been described in the previous paragraphs, such division is exemplary and not mandatory. Practically, according to the embodiments of the present application, the functions and features of two or more modules described above may be embodied in one module. On the other hand, the function and feature of any one module described above may be embodied in two or more modules.

Different data access operations or methods can be realized based on the memory devices shown in FIGS. 1 and 2 and the data access processes shown in FIGS. 3A to 5G.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: receiving through the memory interface a data access command indicating transferring data to be exchanged from the volatile memory module to the non-volatile memory module; and in response to the data access command: transferring the data to be exchanged from the volatile memory module to the memory interface; storing the data to be exchanged from the memory interface to the buffer memory; and transferring the data to be exchanged from the buffer memory to the non-volatile memory module.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: receiving through the memory interface a data access command indicating transferring data to be exchanged from the volatile memory module to the non-volatile memory module; and in response to the data access command: storing the data to be exchanged from the volatile memory module to the buffer memory; and transferring the data to be exchanged from the buffer memory to the non-volatile memory module.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: receiving through the memory interface a data access command indicating transferring data to be exchanged from the non-volatile memory module to volatile memory module; and in response to the data access command: storing the data to be exchanged from the non-volatile memory module to the buffer memory; transferring the data to be exchanged from the buffer memory to the memory interface; and transferring the data to be exchanged from the memory interface to the volatile memory module.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: receiving through the memory interface a data access command indicating transferring data to be exchanged from the non-volatile memory module to the volatile memory module; and in response to the data access command: storing the data to be exchanged from the non-volatile memory module to the buffer memory; and transferring the data to be exchanged from the buffer memory to the volatile memory module.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: receiving through the memory interface a data access command indicating reading data to be exchanged from the non-volatile memory module; and in response to the data access command: storing the data to be exchanged from the non-volatile memory module to the buffer memory; and transferring the data to be exchanged from the buffer memory to the memory interface.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: transferring the data transferred to the memory interface of the original memory device to the memory interface of the target memory device; writing the data from the memory interface of the target memory device into the volatile memory module or the non-volatile memory module of the target memory device.

In other aspects of the application, a data exchange method for a memory device is provided. The memory device comprises a volatile memory module and a non-volatile memory module and exchanging data with an external module through a memory interface, and the memory device further comprises an internal buffer memory. The data exchange method comprises: receiving through the memory interface a data access command indicating writing data to be exchanged into the non-volatile memory module; and in response to the data access command: storing the data to be exchanged from the memory interface to the buffer memory; writing the data to be exchanged from the buffer memory into the non-volatile memory module.

In some embodiments, the data access command further indicates: reading the data to be exchanged from a volatile memory module or a non-volatile memory module of a source memory device before writing the data to be exchanged into the non-volatile memory module. The method further comprises: reading the data to be exchanged from the volatile memory module or the non-volatile memory module of the source memory device to a memory interface of the source memory device before writing the data to be exchanged into the non-volatile memory module of the target memory device; transferring the data transferred to the memory interface of the source memory device to the memory interface of the target memory device. In this way, the memory device may further write the data to be exchanged transferred to the memory interface of the memory device to the volatile memory module or non-volatile memory module of the memory device.

Those skilled in the art may understand and implement other variations to the disclosed embodiments from a study of the drawings, the disclosure, and the appended claims. In the claims, the word “comprising” does not exclude other elements or steps, and the indefinite article “a” or “an” does not exclude a plurality. In applications according to present application, one element may perform functions of several technical feature recited in claims. Any reference signs in the claims should not be construed as limiting the scope.

What is claimed is:

1. A memory device, comprising:
a volatile memory module;
a non-volatile memory module;
a memory interface through which the memory device receives a data access command from an external module and exchanges data with the external module according to the data access command;
an access control module coupled to the memory interface to receive the data access command;
a non-volatile memory controller coupled to the non-volatile memory module and configured to receive the data access command and exchange data with the non-volatile memory module according to the data access command; and
a data buffering module coupled to the non-volatile memory module, the non-volatile memory controller and the memory interface, the data buffering module being further coupled to the access control module to receive the data access command and configured to provide the data access command to the non-volatile memory controller to exchange data with the non-volatile memory controller according to the data access command;
wherein the data buffering module comprises a buffer memory configured to store at least a portion of data exchanged through the data buffering module.

2. The memory device of claim 1, wherein the at least a portion of data exchanged through the data buffering module comprises data exchanged between the memory interface and the non-volatile memory controller.

3. The memory device of claim 2, wherein the at least a portion of data exchanged through the data buffering module further comprises data exchanged between the volatile memory module and the non-volatile memory controller.

4. The memory device of claim 1, wherein the data buffering module is configured to obtain or set status data of the non-volatile memory controller before exchanging data with the non-volatile memory controller.

5. The memory device of claim 1, further comprising a data exchange channel coupled between the non-volatile memory controller and the data buffering module, the data exchange channel being configured to receive a data strobe signal and transfer the data access command and data between the non-volatile memory controller and the data buffering module according to the data strobe signal.

6. The memory device of claim 5, wherein the data exchange channel is a bi-directional channel.

7. The memory device of claim 1, further comprising:
an access control bus coupled between the access control module and the data buffering module for transferring the data access command from the access control module to the data buffering module.

8. The memory device of claim 1, further comprising:
a power-failure saving signal channel coupled between the memory interface and the non-volatile memory controller, the power-failure saving signal channel being configured to receive a power-failure saving signal and provide it to the non-volatile memory controller;
the non-volatile memory controller being further configured to control the access control module and the data buffering module in response to the power-failure saving signal to transfer data stored in the volatile memory module to the non-volatile memory module.

9. The memory device of claim 1, wherein the buffer memory is further configured to store operation information and/or command required for data exchange operation on the non-volatile memory module.

10. The memory device of claim 1, wherein the volatile memory module comprises a plurality of groups of volatile memory cells, the data buffering module comprises a plurality of groups of data buffering units, the buffer memory comprises a plurality of groups of buffer memory cells, and wherein each group of volatile memory cells corresponds to one group of data buffering units and one group of buffer memory cells.

11. The memory device of claim 1, wherein the memory interface is a double data rate (DDR) interface.

12. A memory device, comprising:
a volatile memory module;
a non-volatile memory module;
a memory interface through which the memory device receives a data access command from an external module and exchanges data with the external module according to the data access command;
an access control module coupled to the memory interface to receive the data access command;
a non-volatile memory controller coupled to the non-volatile memory module and configured to receive the data access command and exchange data with the non-volatile memory module according to the data access command; and
a data buffering module with a buffer memory, the data buffering module being coupled to the non-volatile memory module, the non-volatile memory controller and the memory interface, and further coupled to the access control module to receive the data access command; and the buffer memory being configured to store data when data is exchanged between the non-volatile memory controller and the volatile memory module or between the non-volatile memory module and the memory interface, and not to store data when data is exchanged between the volatile memory module and the memory interface.

13. A data exchange method for a memory device comprising a volatile memory module and a non-volatile memory module and exchanging data with an external module through a memory interface, the memory device further comprising an internal buffer memory, and the data exchange method comprising:
receiving through the memory interface a data access command indicating transferring data to be exchanged from the volatile memory module to the non-volatile memory module; and
in response to the data access command:
storing the data to be exchanged from the volatile memory module to the buffer memory, and
transferring the data to be exchanged from the buffer memory to the non-volatile memory module;
or
receiving through the memory interface a data access command indicating transferring data to be exchanged from the non-volatile memory module to the volatile memory module; and
in response to the data access command:
storing the data to be exchanged from the non-volatile memory module to the buffer memory; and
transferring the data to be exchanged from the buffer memory to the volatile memory module.

14. The data exchange method of claim 13, storing the data to be exchanged from the volatile memory module to the buffer memory comprising:
transferring the data to be exchanged from the volatile memory module to the memory interface; and
storing the data to be exchanged from the memory interface to the buffer memory.

15. The data exchange method of claim 13, transferring the data to be exchanged from the buffer memory to the volatile memory module comprising:
transferring the data to be exchanged from the buffer memory to the memory interface; and
transferring the data to be exchanged from the memory interface to the volatile memory module.

16. A data exchange method for a memory device comprising a volatile memory module and a non-volatile memory module and exchanging data with an external module through a memory interface, the memory device further comprising a buffer memory, and the data exchange method comprising:
receiving through the memory interface a data access command indicating reading data to be exchanged from the non-volatile memory module; and
in response to the data access command:
storing the data to be exchanged from the non-volatile memory module to the buffer memory; and
transferring the data to be exchanged from the buffer memory to the memory interface;
or
receiving through the memory interface a data access command indicating writing data to be exchanged into the non-volatile memory module; and
in response to the data access command:
storing the data to be exchanged from the memory interface to the buffer memory; and
writing the data to be exchanged from the buffer memory into the non-volatile memory module.

17. The data exchange method of claim 16, wherein the data access command further indicates transferring the data to be exchanged to a volatile memory module or a non-volatile memory module of a target memory device, and the data exchange method further comprising:
transferring the data transferred to the memory interface of the original memory device to the memory interface of the target memory device; and
writing the data from the memory interface of the target memory device into the volatile memory module or the non-volatile memory module of the target memory device.

18. The data exchange method of claim 16, wherein the data access command further indicates reading the data to be exchanged from a volatile memory module or a non-volatile memory module of a source memory device before writing the data to be exchanged into the non-volatile memory module, and the method further comprising:
reading the data to be exchanged from the volatile memory module or the non-volatile memory module of the source memory device to a memory interface of the source memory device before writing the data to be exchanged into the non-volatile memory module of the target memory device; and
transferring the data transferred to the memory interface of the source memory device to the memory interface of the target memory device.

19. The data exchange method of claim 13, wherein the data access command is stored in the buffer memory.

20. The data exchange method of claim 13, wherein the buffer memory is within a data buffering module of the memory device.
